(19) United States
(12) Patent Application Publication
(10) Pub. No.: US 2025/0282082 A1
(43) Pub. Date: Sep. 11, 2025

(54) INSTANT HYDRATING POLYACRYLAMIDE GRANULES

(71) Applicant: SOLENIS TECHNOLOGIES, L.P., Wilmington, DE (US)

(72) Inventors: Zhaoqing Liu, Newark, DE (US); Yanrong Lu, Newark, DE (US)

(73) Assignee: SOLENIS TECHNOLOGIES, L.P., Wilmington, DE (US)

(21) Appl. No.: 19/064,907

(22) Filed: Feb. 27, 2025

Related U.S. Application Data
(60) Provisional application No. 63/561,747, filed on Mar. 6, 2024.

(51) Int. Cl. B29B 9/16; B29B 9/12; B29K 77/00; C08J 3/12; C08J 7/06

(52) U.S. Cl. CPC B29B 9/16; B29B 9/12; C08J 3/128; C08J 7/065; B29B 2009/163; B29K 2077/00; B29K 2995/0062; B29K 2995/0092; C08J 2333/26

(57) ABSTRACT

Provided are compositions and methods for the instant hydration of polyacrylamide granules of particle size greater than 500 μm comprising the same polyacrylamide powder of particle size less than 500 μm; and a binding agent or agents. More particularly, the polyacrylamide powder is combined with a water-destroyable binding agent forming polyacrylamide granules, which instantly hydrates when added to water.

### CROSS-REFERENCE TO RELATED APPLICATIONS

This application claims the benefit of U.S. Provisional Patent Application No. 63/561,747, filed 6 Mar. 2024, the entire contents of which are hereby incorporated by reference.

### TECHNICAL FIELD

The present disclosure generally relates to compositions and methods for the instant hydration of polyacrylamide granules of particle size greater than 500 μm comprising the same polyacrylamide powder of particle size less than 500 μm; and a binding agent or agents. More particularly, the polyacrylamide powder is combined with a water-destroyable binding agent forming polyacrylamide granules, which instantly hydrates when added to water.

### BACKGROUND

Polyacrylamide products are produced in solid, beads, aqueous solution, aqueous dispersion, and inverse emulsion. The aqueous solution or dispersion is limited to low active and/or products of low molecular weight. The water-in-oil inverse emulsion could achieve active as high as 45%, it utilizes VOC solvents.

Although polyacrylamide micro-beads are solid and highly active, the process efficiency is lower, and the polymerization reaction takes place at about 20% active monomer/polymer in a VOC solvent which has to be purified and recycled. The solid obtained by gel polymerization is considered the most sustainable process of choice. The high active products, usually at 30 to 40% active monomer/polymer, are produced in gel form, grinded, and dried continuously. However, hydration of rough grinded powder, usually having particle size distributions of about 500 μm to about 1500 μm, takes tens of minutes up to hours to complete. The long hydration time limits its use in a wider array of applications such as oil fields. Therefore, short hydration times are needed for almost all of its uses to save time, space, and capital cost of equipment.

Traditionally, fine grinding to less than 300 μm to produce powder of narrower particle size distribution has been used for short hydration times of less than 30 minutes with specially designed make-down equipment to avoid agglomeration or “fish-eyes” formation. As an alternative to avoid agglomeration, the fine powder can also be suspended or dispersed with or without a wetting surfactant(s) or/and suspending agent(s) in an organic solvent and then hydrated. Use of organic solvent increases the cost and environmental impact. On the other hand, fine powder has dust issues and elimination of dust during process, transportation and use of the products could reduce the loss of products, protect the health and safety of the workers and the environment.

Traditionally, specially designed make-down equipment is used to disperse the powder under high shear through so-called PSU or polymer slicing unit. As an alternative, the fine powder can also be dispersed in an organic solvent and then hydrated under high shear where organic solvent is used to make polyacrylamide powder slurry suspension or dispersions before the product could be properly dispersed into water under shear. The high shear delivery of the powder or its suspension/dispersion not only consumes energy, but also decreases the polymer molecular weight due to the mechanical action, thus reducing the performance of the polymer which is associated with its high molecular weight.

Other techniques utilize foams to generate porous polyacrylamide granules, which was claimed to have shortened the gel drying time and the powder dissolution time, but only marginally. Still other processes to make fast hydrating polyacrylamide include introducing a cross-linked hydrophilic polymer, such as carboxymethyl starch, to a polyacrylic acid superabsorbent. These so-called disintegrants, which are generally added during polymerization or to the wet gel, only marginally shorten the hydration time.

A product which eliminates the fine-powder dust, does not need high shear for dissolution in water or the use of solvent to aim the dispersion of the polymer particles is needed from the viewpoint of cost and sustainability development.

Accordingly, it is desirable to provide compositions and methods that allow for shorter hydration times of polyacrylamides without the drawbacks mentioned above. Furthermore, other desirable features and characteristics of the present disclosure will become apparent from the subsequent detailed description and the appended claims, taken in conjunction with the accompanying drawings and this background.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Provided is a method of preparing a water-disintegrating polyacrylamide granule, said method comprising: providing a polyacrylamide powder comprising particles having a D₉₀ particle size of less than about 500 μm, providing a binding agent chosen from alkali earth halides, nitrates, or any substances which bind the powder particles at low moisture content but not in bulk water, and combinations thereof; combining the polyacrylamide powder and the binding agent to form polyacrylamide granules having a D₉₀ granule size, wherein the average granule size is greater than the average particle size of the particles of the polyacrylamide powder.

Also provided is a polyacrylamide composition comprising polyacrylamide particles; and a water-destroyable binding agent chosen from calcium chloride, magnesium chloride, magnesium bromide, calcium bromide, calcium nitrate, magnesium nitrate, zinc nitrate, hydrates thereof, any substances which bind the powder particles at low moisture content but not in bulk water, and combinations thereof. The polyacrylamide particles in the powder will be bonded to form granules wherein the binder disintegrates the granules upon their contact with bulk water, leaving dispersed particles of polyacrylamide in the liquid without lump formation, thus decreasing the dissolution time of the particles.

### BRIEF DESCRIPTION OF THE DRAWINGS

The present disclosure will hereinafter be described in conjunction with the following drawing figures, wherein like numerals denote like elements, and wherein:

FIG. 1, depicts the hydration of Terpolymer of AA-AMPS-AM in fresh water, Granules vs Powder.

FIG. 2, depicts the hydration of Praestol® 2530, D₉₀=136 microns in fresh water, Granules vs Powder.

FIG. 3, depicts the hydration of Praestol® 2530, D₉₀=169 microns, in fresh water.

FIG. 4, depicts the hydration of granules from Nuoer products in fresh water.

FIG. 5, depicts the hydration of granules from Praestol® 2530, 251 microns, in fresh water.

FIG. 6, depicts the hydration of granules from Praestol® 2530, 251 microns, in fresh water.

FIG. 7, depicts the hydration of granules from Praestol® 2530, 251 microns, in fresh water.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims.

Furthermore, there is no intention to be bound by any expressed or implied theory presented in the preceding technical field, background, brief summary, or the following detailed description.

Unless specifically stated or obvious from context, as used herein, the term “about” is understood as being within a range of normal tolerance in the art, for example within 2 standard deviations of the mean. “About” can be understood as being within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

Provided is a method of preparing a water-disintegrating polyacrylamide granule, that is, the granule would disintegrate and disperse the bonded particles upon contact with bulk water to form a transient suspension or dispersion, allowing the “freed” fine particles to dissolve as individual particles without lump formation. By fine particles is meant the particles that are associated with the original powder. A polyacrylamide powder comprising fine particles having an average particle size (D₉₀, that is, 90% of the total particles are smaller than this size) of less than about 500 μm is provided and combined with a water-destroyable binding agent or binder. What is meant by a “water-destroyable binder” is a binder or a combination of binders and additives, which when combined with the polyacrylamide powder, will form polyacrylamide granules comprising polyacrylamide particles in dry solid or semi-solid form at low water content.

The water-destroyable binding agent interacts with the particles of the polyacrylamide powder to form granules, which comprise an agglomeration of the particles, or simply deposits on the surface of the particles or binds the polyacrylamide powder particles on other particles such as frac sands. The binding agents of the present composition lose their binding ability when submerged or immersed in water. The binders are destroyed by bulky water through dissolution in water or/and reaction with water or/and any other mechanisms. When added to water, the polyacrylamide granules disassociates, and/or disintegrates, leaving only the free fine polyacrylamide particles suspended or dispersed in the water in a transition state. This transient suspension or dispersion will then become homogenous in water in less than 15 minutes.

In addition, the binding agent when in liquid form, does not solubilize the polyacrylamide nor swell the polyacrylamide powder so as to soften the particles, which results in non-disintegrable granules. The water-destroyable binding agent can be chosen from, for example, alkali earth halides, nitrates, zinc nitrate, ferric chloride, and their hydrates; or a combination of substances of a traditional water-soluble binding agent such as sucrose, glucose, sorbitol, and a disintegrant such as aluminum sulfate or its hydrate. The binding agent can be provided as an aqueous liquid or in solid form. The polyacrylamide powder and binding agent are combined and mixed, resulting in polyacrylamide granules being formed. The granules are an agglomeration of the particles of the polyacrylamide powder held together by the binding agent, or simply coated by the binding agent. Such granules could also be bonded onto other particles than polyacrylamide powder, for example, frac sand particles. The resulting polyacrylamide granules have an average granule size greater than the average particle size of the particles of the polyacrylamide powder. The “wet” granules can be used directly or be cooled and/or dried for packaging, distribution, and storage.

In some aspects of the method, polyacrylamide granules of greater than 500 μm are prepared from its powder wherein the particles of the powder have an average particle size of less than 500 microns. Relatively dry powdered polyacrylamide particles are combined with the water-destroyable binding agent forming granules having a limited moisture content. In the presence of an excessive amount of water, the binder will lose its binding capability, and the granules will disintegrate into the original size of the powdered particles thus setting the bonded particles free, which happens upon contact with water. This can be done under low to moderate shear which would not mechanically break the polymer chains, and the freed fine particles will more easily disperse and dissolve in water.

In some aspects of the method, the “wet” polyacrylamide granules in semi-solid form can be molded in shape such as cylindrical pellets, cooled and/or dried for distribution and/or further processing.

In other aspects of the method, the polyacrylamide granules can be crushed and/or classified, and the polyacrylamide granules having an average granule size greater than the size of the particles of the polyacrylamide powder collected.

In some aspects of the method, the binding agent is provided as a solid and liquifies when heated to a temperature of from about 25° C. to about 95° C., and can be at a temperature of from about 30° C. to about 70° C. The binding agent is combined with the polyacrylamide powder as a solid and heated to a temperature at which the binding agent melts and melt granulation occurs wherein the binding agent binds the individual particles of the powder into granules. Blending and melt granulation, either with solid or liquid form of the binding agent can be carried out simultaneously or sequentially. The wet granules can be used directly in situ or cooled and/or dried forming polyacrylamide granules having low water content for distribution and storage. Drying is not necessary if water content is low, and granulation occurs upon cooling the mixture down to room temperature. If the water content of the polymer powder is high enough, the binding agent can be used at a slightly higher granulation temperature without additional water.

In some aspects of the method, the polyacrylamide granules disintegrate, dissociate and/or dissolve in water at room temperature in less than about 600 seconds, or less than about 300 seconds, or less than about 60 seconds, or less than about 30 seconds.

In other aspects of the method, before the polyacrylamide granules are cooled and/or dried, the granules can go through a molding and/or sieving step to produce a uniform shape and/or size of granule. The polyacrylamide granules can be dried at a temperature of from about 50° C. to about 100° C., and can be dried at a temperature of from about 70° C. to about 90° C.

In other aspects of the method, after the polyacrylamide granules are cooled and/or dried, the granules can go through a crashing/sorting and/or sieving step to produce a more uniform size of granules. The polyacrylamide granules can be dried at a temperature of from about 50° C. to about 100° C., and can be dried at a temperature of from about 70° C. to about 90° C.

In yet other aspects of the method, the binding agent can be chosen from calcium chloride, magnesium chloride, magnesium bromide, calcium bromide, calcium nitrate, magnesium nitrate, zinc nitrate, their hydrates thereof, and combinations thereof. For example, the hydrate can be chosen from hexahydrates, tetrahydrates, dihydrates, such as, calcium chloride hexahydrate, calcium chloride tetrahydrate, calcium chloride dihydrate, zinc nitrate hexahydrate, zinc nitrate 2-4 hydrate, calcium bromide hexahydrate, calcium bromide tetrahydrate, calcium bromide dihydrate, magnesium nitrate hexahydrate, calcium nitrate tetrahydrate, and combinations thereof.

In some aspects of the method, the binding agent is a solid having a melting point of from about 20° C. to about 90° C., or from about 30° C. to about 60° C.

In yet other aspects of the method, the binding agent is an aqueous liquid that solidifies at a temperature of from about 25° C. to about 95° C.

Also provided is a polyacrylamide composition comprising polyacrylamide particles; and a water-destroyable binding agent chosen from calcium chloride, magnesium chloride, magnesium bromide, calcium bromide, calcium nitrate, magnesium nitrate, zinc nitrate, hydrates thereof, and combinations thereof.

In some aspects of the composition, the hydrate is chosen from calcium chloride hexahydrate, calcium chloride tetrahydrate, calcium chloride dihydrate, zinc nitrate hexahydrate, zinc nitrate 2-4 hydrate, calcium bromide hexahydrate, calcium bromide tetrahydrate, calcium bromide dihydrate, magnesium nitrate hexahydrate, calcium nitrate tetrahydrate, and combinations thereof.

In yet other aspects, the polyacrylamide compositions comprise surfactants, aluminum salt, and commonly used binding agent such as sucrose, glucose, sorbitol. The granules disintegrate and dissociate in water and dissolves in alkaline water.

In yet other aspects, the polyacrylamide composition can further comprise other processing and functional additives, which can be blended with the water-destroyable binder or with polyacrylamide powder, so long as they do not adversely affect the granulation, dissolution, and functionalization of the polyacrylamide. The additives can include, for example, surfactants, corrosion inhibitors, scale inhibitors, biocides, free-flowing agents, frac sands.

Finally, the polyacrylamide granules can be used in various applications in water-treatment, mining, petroleum exploration and recovery processes.

### EXAMPLES

### Example #1

A 50.01 gram (g) sample of powdered sample of terpolymer of acrylic acid, 2-acrylamido-2-methyl-1-propanesulfonic acid, and acrylamide sodium salt (80 mesh) was mixed with 0.576 g of 50% sorbitan monooleate in Conosol® C170 hydrocarbon solvent, thereby treating the surfaces of the particles of the powdered sample. The treated powder was then mixed with 7.66 g of ground calcium chloride hydrate (54.5% calcium chloride, obtained from cooling its warm aqueous solution) and heated to 50° C. on a hot plate while mixing until granulation occurred. The granulated polyacrylamide was dried at a temperature of 80° C. to 90° C. and sieved through a 1 mm sieve. When added to water, the granular polymer was observed to sink below the water surface, disintegrate as fine particles and dissolve in water without aggregation observed.

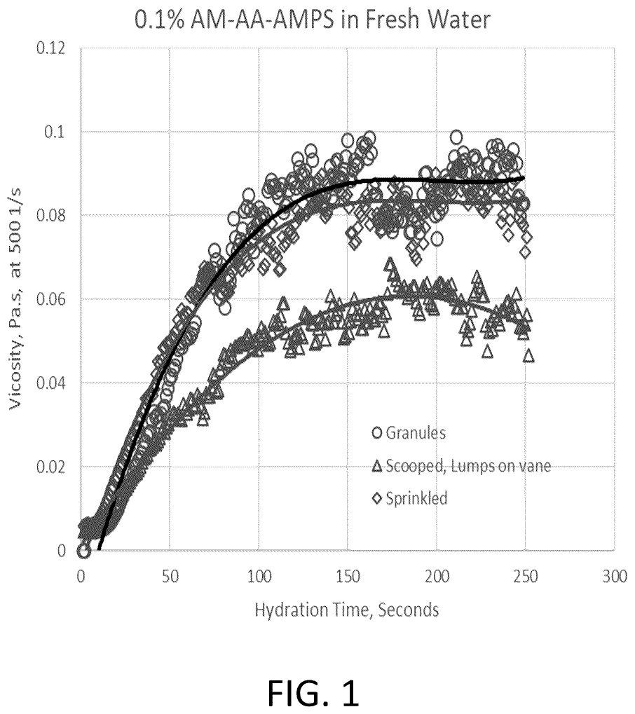

Aqueous solutions of the granules with concentrations up to 5%, whose viscosity allows for mixing, was prepared by hand mixing with a rod or by mechanic mixer in either fresh water or in the presence of electrolytes. The hydration of the granules (0.10 g in 80 ml water placed in 100 ml beaker) was monitored in tap water according to the nominal viscosity on a Discovery HR-2 Hybrid Rheometer equipped with a vane at a nominal 500 second-1 shear rate. In comparison, the hydration of the untreated powder at equal active polymer without granulation was also monitored (see FIG. 1). It was found that the dissolution rate of the polyacrylamide granules added in bulk, was identical to the polyacrylamide powder, only if the powder was sprinkled into the water as separated particles. In this instance, both the granule and the powder hydrated within 150 seconds. However, if the powder was also added in bulk into the water, aggregates of particles were observed on the shaft of the stirrer indicating incomplete hydration of the polyacrylamide powder, and dissolution time of the particles was observed to take longer than the granulated polymer.

### Example #2

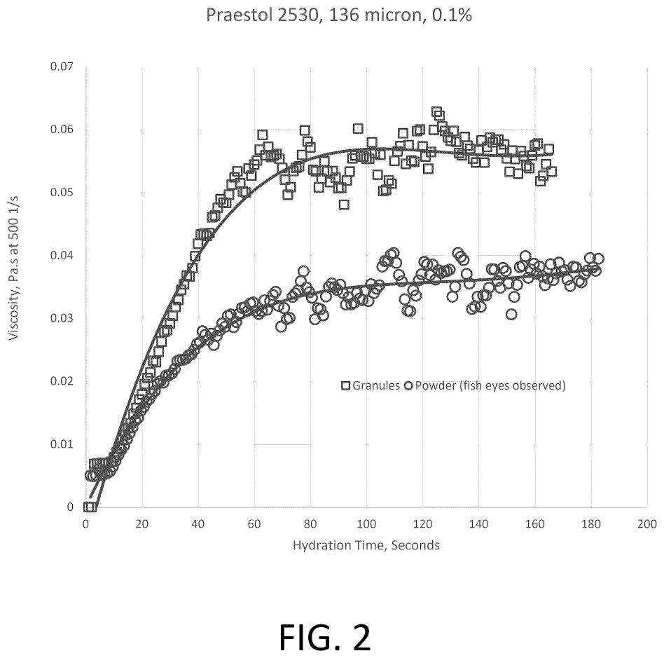

The same procedure as described in Example 1, was used in the following example. A 5.03 gram (g) sample of Praestol® 2530 powder having a particle size of 136 μm (D90 by light scattering) comprising a copolymer of acrylic acid and acrylamide, was treated with 0.059 g of 50% sorbitan monooleate in Conosol® C170. The treated powder was mixed and granulated with 1.00 g calcium chloride hydrate (54.5% CaCl₂) as Example #1) of a mixture of hexa- and tetrahydrates at 50° C. on a heating plate. The granules were dried and sieved through 1 mm sieve. The hydration rate of a treated and untreated powder was compared, and results can be seen in FIG. 2. Unlike the powder which floated on the water surface and formed fisheyes upon mixing, the formed granules quickly sank below the water line and disperse as separated particles, which dissolved within 1 minute.

### Example #3

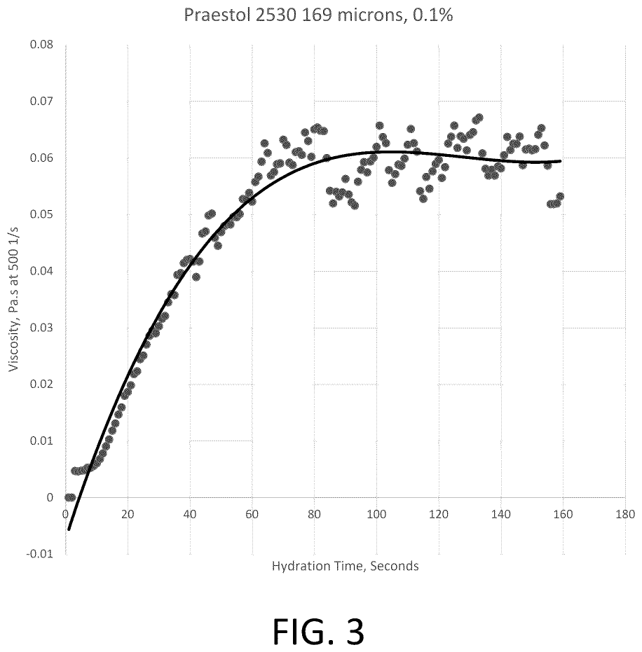

The same procedure as described in Example 1, was used in the following example. A 5.097 g sample of Praestol® 2530 powder of particle size of 169 microns (D90 by light scattering) comprising a copolymer of acrylic acid and acrylamide, was mixed, and granulated with 0.755 g calcium chloride hydrates (60% CaCl₂, prepared by adding water directly to calcium chloride dihydrates with mixing) of a mixture of hexa- and tetrahydrates at 50° C. on a heating plate. The granules were dried and sieved through 1 mm sieve. The hydration rate was observed until a constant viscosity was reached within 80 seconds (FIG. 3)

### Example #4-7

Commercial products from Nuoer were granulated according to the present method. Samples of 54.5% calcium hydrate were prepared and evaluated as in Example #1.

TABLE 1
Granulation of NuoerFloc Products

| Example # | 4 | 5 | 6 | 7 |
|---|---|---|---|---|
| Product Name | NuoerFloc | NuoerFloc | NuoerFloc | NuoerFloc |
| | ZR048 | 8105C | 8384B | ZR044 |
| MW, in millions | 25-30 | 18-21 | 11-13 | 20-25 |
| Polymer | Anionic | Anionic | Sulfonated | Anionic from post |
| | | | Anionic | hydrolysis |
| Charge Density | <25% | 25-30% | N/A | 20-25% |
| Size, D90 microns | 234 | 298 | 224 | 249 |
| Powder, (g) | 25.05 | 25.00 | 25.00 | 38.20 |
| 54.5% CaCl2•xH₂O, | 4.51 | 4.51 | 4.52 | 6.88 |
| (g) | | | | |

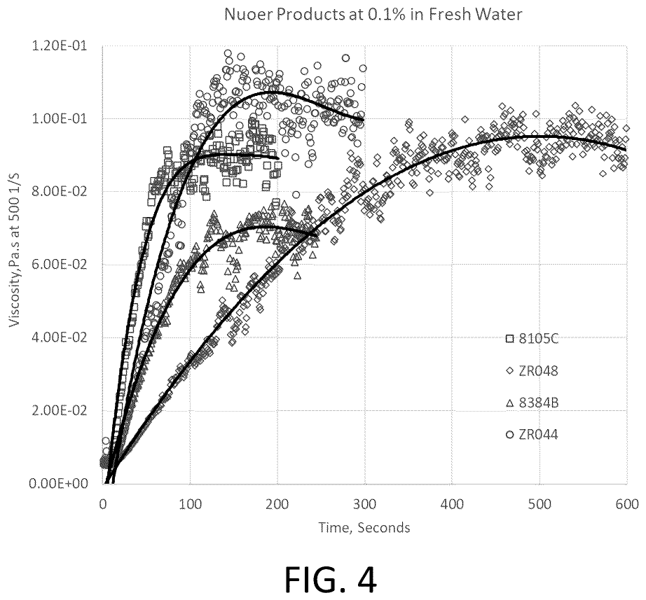

As can be seen in FIG. 4, all of the granulated samples 4-7, provided good dissolution rates without the aggregation of the individual particles.

### Example #8

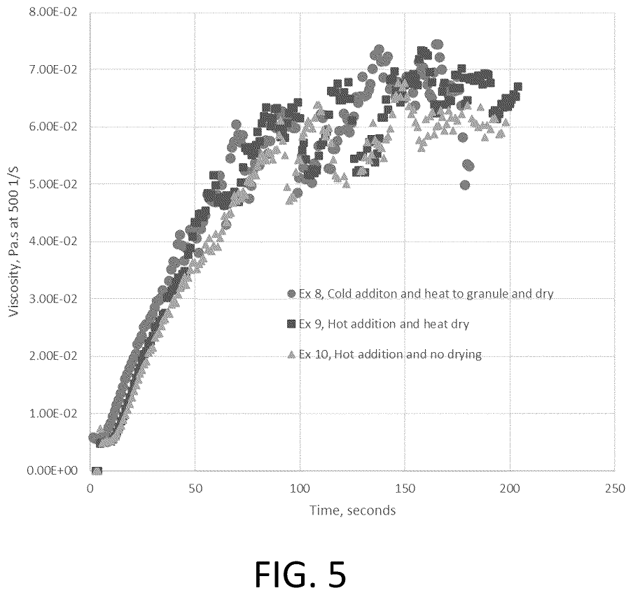

Following the same procedure as outlined in Example 1, a 5.02 g sample of Praestol® 2530 powder of particle size of 251 μm (D90 by light scattering) comprising a copolymer of acrylic acid and acrylamide, was mixed with 0.54 g of a 52.9% warm aqueous solution of calcium chloride. The mixture was then granulated at 50° C. on a heating plate. The granules were dried and sieved through 1 mm sieve. The hydration was observed to reach constant viscosity within 80 seconds (FIG. 5, 0.1% in fresh water).

### Example #9

The same procedure as Example #8 was used except the powder was heated to 50° C. so the mixing and granulation were carried out simultaneously. The hydration curve is shown in FIG. 5 for comparison.

### Example #10

The same procedure as in Example #9 except no drying was applied. The granules were simply cooled down to room temperature. The hydration curve is shown in FIG. 5 for comparison.

### Example #11-12

The same procedure as shown in Example #1 was used instead Praestol® 2530 (D₉₀=143 μm, 14% water measured at 150° C.) and anhydrous calcium chloride was used (Table 2 in grams), and the temperature for granulation was increased to between 70° C. and 80° C. The amount of water from the polymer was calculated to be enough to transform the calcium chloride into its melting hydrates.

TABLE 2
Granulation of Praestol ® 2530 with Anhydrous CaCl₂

| Example | Praestol ® 2530 | | % Water with Polymer Granules | | |
|---|---|---|---|---|---|
| # | 16% water | CaCl₂ | 6H₂O | 4H₂O | 2H₂O |
| 11 | 5 g | 0.5 g | 9% | 10% | 12% |
| 12 | 5 g | 0.4 g | 10% | 11% | 12% |

### Example #13-15

A similar procedure was followed as those above, except granulation was done at room temperature instead of 50° C. The formulations can be found in Table 3. The salts were dissolved in the prescribed amounts of water and then added to the Praestol® 2530 powder to initiate the granulation. The wet granulated mixture was air-dried and sieved through 1 mm sieve. Note that when warmer temperatures were used, non-disintegrable granules were obtained.

### Example #16-20

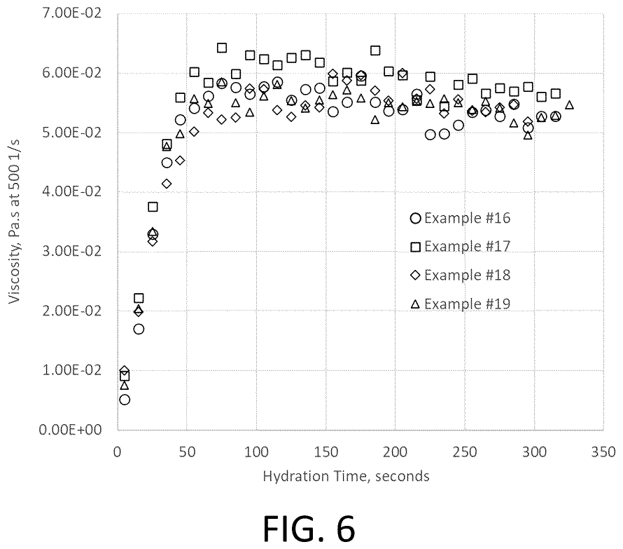

In Examples 16-20, a blend of calcium chloride and magnesium chloride binder solution was prepared using the formulations and the dissolution temperatures shown in Table 3. The binder solution was heated to the indicated temperatures and added to the heated powder to carry the granulation. The composition was then dried at a temperature of 80° C. to 90° C. and sieved through 1 mm sieve. This blend of calcium and magnesium chlorides as the binding agent was observed to accelerate the hydration of the granules (see FIG. 6).

TABLE 3
Granules from CaCl₂ Binder Blends

| Ex # | 13 | 14 | 15 | 16 | 17 | 18 | 19 | 20 |
|---|---|---|---|---|---|---|---|---|
| CaCl₂ (g) | 0.136 | 0.154 | 0.166 | 0.096 | 0.225 | 0.308 | 0.352 | 0.428 |
| MgCl₂:6H₂O (46.8% MgCl₂) | | | | 0.368 | 0.269 | 0.124 | 0.143 | 0.085 |
| (g) | | | | | | | | |
| NaBr (g) | 0.011 | | 0.013 | | | | | |
| OCI (g) | | 0.026 | | | | | | |
| Water (g) | 0.273 | 0.334 | 0.334 | 0.308 | 0.224 | 0.303 | 0.246 | 0.257 |
| Praestol ® 2530, 143 μm (g) | 5.002 | 5.025 | 5.025 | 5.023 | 5.015 | 5.019 | 5.246 | 5.018 |
| Dissolution temperature, ° C. | 25 | 25 | 25 | 25 | 82 | 68 | 95 | 85 |
| % Salt in Water | 35.0 | 35.0 | 35.0 | 34.7 | 48.9 | 49.8 | 56.5 | 60.7 |
| Wet Granule Composition: | | | | | | | | |
| Praestol ® 2530 | 92.3 | 90.7 | 90.7 | 86.7 | 87.5 | 87.2 | 87.6 | 86.7 |
| Salts | 2.7 | 3.2 | 3.2 | 4.6 | 6.1 | 6.4 | 7.0 | 8.1 |
| Water | 5.0 | 6.0 | 6.0 | 8.7 | 6.4 | 6.4 | 5.4 | 5.2 |

### Examples 21-25

In these examples, aluminum salt was used to make polyacrylamide granules in which external activation to dissolve the dispersed fine particles is needed. A viscoelastic liquid was prepared from Alpha-Step® PC-48 (Fatty acid methyl ester sulfonate, from Stepan) and Stepan Mild GCC (glyceryl monooctanoate, Stepan) containing aluminum salt and other supporting additives as listed in grams in Table 4. The prepared liquid was then used as a binder to granulate Praestol® 2530 (D₉₀, 140 μm) with the amount listed in Table 4. The wet mixture was then dried at a temperature 80° C. to 90° C. to obtain granules of about 1000 μm in size. All granules were observed to disperse well in water and disintegrated into the original powder sizes. The freed particles dissolved slowly in water and total hydration was difficult to observe due to gel formation caused by cross-linking of the dissolved polymer with aluminum salt. However, when caustic soda was added to the water to raise the pH above 11 and to prevent cross-linking of the polymer, the dissolution was instant, usually within 1 to 2 minutes. The higher the pH, the faster the dissolution.

TABLE 4
Praestol ® 2530 Powder Granules

| Example # | 21 | 22 | 23 | 24 | 25 |
|---|---|---|---|---|---|
| Aluminum Sulfate, 18 water hydrate | 3.42 | 4.28 | 0.72 | 0.52 | 0.52 |
| Sodium Sulfate | | | | 0.31 | 0.31 |
| Alpha-Step ® PC-48, 38.5% | 1.41 | 1.77 | 0.59 | 0.50 | 0.50 |
| Stepan Mild GCC | 0.97 | 1.21 | 0.18 | | |
| Sucrose | | | 0.60 | 0.60 | 0.80 |
| Water | 10.21 | 12.76 | 0.91 | 1.07 | 1.19 |
| Praestol ® 2530, 140 μm | 19.99 | 20.02 | 10 | 10 | 10 |

### Example #26

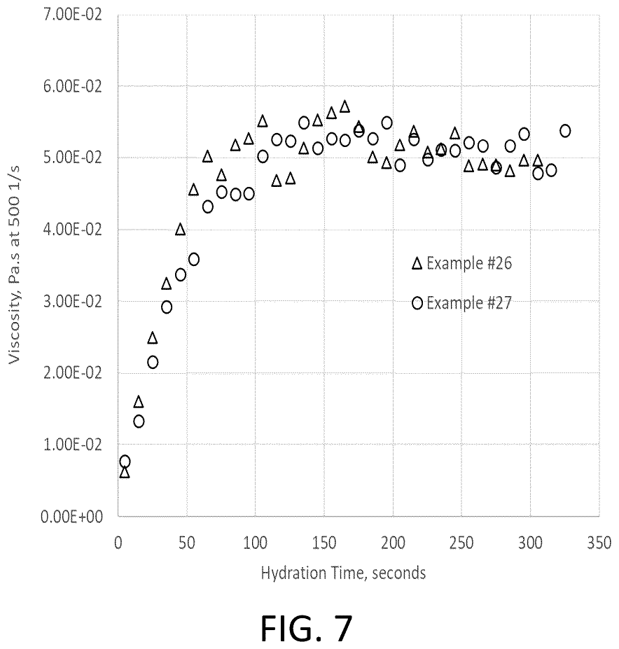

A 5.031 gram sample of Praestol® 2530 powder of particle size of 251 microns (D₉₀ by light scattering) comprising a copolymer of acrylic acid and acrylamide was granulated as in Example #1 by mixing and heating with 0.716 g calcium bromide hydrate (89.6% CaBr₂) in 0.203 grams at a temperature of about 80° C. The wet granules were pushed through a 1 mm sieve and dried at a temperature of 80° C. to 90° C. on a hot plate. The hydration profile can be seen in FIG. 7.

### Example #27

The same procedure as in Example #24 was followed except 5.028 g Praestol® 2530 was used with 1.007 grams of the powdery calcium bromide hydrate directly without water. The obtained granules were evaluated according to the hydration profile seen in FIG. 7.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It being understood that various changes may be made in the function and arrangement of elements described in an exemplary embodiment without departing from the scope of the present disclosure as set forth in the appended claims.

We claim:

1. A method of preparing a disintegrating polyacrylamide granule, said method comprising:
providing a polyacrylamide powder comprising particles having an average particle size (D₉₀) of less than about 500 μm,
providing a binding agent chosen from alkali earth halides, nitrates, and combinations thereof;
combining the polyacrylamide powder and the binding agent to form polyacrylamide granules having an average granule size (D₉₀), wherein the average granule size is greater than the average particle size of the particles of the polyacrylamide powder.

2. The method according to claim 1, further comprising the step of cooling and/or drying the polyacrylamide granules.

3. The method according to claim 1, further comprising the step of classifying and collecting the polyacrylamide granules having an average granule size greater than the size of the particles of the polyacrylamide powder.

4. The method according to claim 1, wherein the binding agent is provided as a solid and the polyacrylamide powder and binder agent are heated thus forming the polyacrylamide granules.

5. The method according to claim 1, wherein the polyacrylamide granules dissolve in water at room temperature in less than about 600 seconds.

6. The method according to claim 1, further comprising the step of molding and/or sieving the polyacrylamide granules.

7. The method according to claim 1, further comprising the step of crushing the polyacrylamide granules.

8. The method according to claim 1, further comprising the step of drying the polyacrylamide granules are dried at a temperature of from about 50° C. to about 100° C.

9. The method according to claim 1, wherein the binding agent is chosen from calcium chloride, magnesium chloride, magnesium bromide, calcium bromide, calcium nitrate, magnesium nitrate, zinc nitrate, hydrates thereof, and combinations thereof.

10. The method according to claim 9, wherein the hydrate is chosen from hexahydrates, tetrahydrates, dihydrates, and combinations thereof.

11. The method according to claim 10, wherein the hydrate is chosen from calcium chloride hexahydrate, calcium chloride tetrahydrate, calcium chloride dihydrate, zinc nitrate hexahydrate, zinc nitrate 2-4 hydrate, calcium bromide hexahydrate, calcium bromide tetrahydrate, calcium bromide dihydrate, magnesium nitrate hexahydrate, calcium nitrate tetrahydrate, and combinations thereof.

12. The method according to claim 1, wherein the binding agent has a melting point of from about 20° C. to about 90° C., or from about 30° C. to about 60° C.

13. The method according to claim 1, wherein the binding agent is an aqueous liquid.

14. The method according to claim 1, wherein the liquid binding agent solidifies at a temperature of from about 25° C. to about 90° C.

15. The method according to claim 1, further comprising a step of providing an additive(s) and a step of combining the additive(s) with the polyacrylamide powder and/or binding agent.

16. The method according to claim 1, wherein the polyacrylamide granule disintegrates or dissociates into polyacrylamide particles the same size of the particles of the powder from which the granule was made.

17. A polyacrylamide composition comprising polyacrylamide particles; and
a binding agent chosen from calcium chloride, magnesium chloride, magnesium bromide, calcium bromide, calcium nitrate, magnesium nitrate, zinc nitrate, hydrates thereof, and combinations thereof.

18. The composition according to claim 17, wherein the hydrate is chosen from calcium chloride hexahydrate, calcium chloride tetrahydrate, calcium chloride dihydrate, zinc nitrate hexahydrate, zinc nitrate 2-4 hydrate, calcium bromide hexahydrate, calcium bromide tetrahydrate, calcium bromide dihydrate, magnesium nitrate hexahydrate, calcium nitrate tetrahydrate, and combinations thereof.

19. The composition according to claim 17, further comprising additional additives.

20. Use of the polyacrylamide granules according to claim 1, in water-treatment, mining, petroleum exploration and recovery processes.
